(19) United States
(12) Patent Application Publication
(10) Pub. No.: US 2011/0029985 A1
(43) Pub. Date: Feb. 3, 2011

(54) METHOD AND APPARATUS FOR COORDINATING RESOURCE ACCESS

(75) Inventors: Sergey Balandin, Helsinki (FI); Ian Justin Oliver, Soderkulla (FI); Sergey Boldyrev, Soderkulla (FI); Jukka Honkola, Espoo (FI)

Correspondence Address: DITTHAVONG MORI & STEINER, P.C., 918 Prince Street, Alexandria, VA, 22314, US

(73) Assignee: Nokia Corporation, Espoo (FI)

(21) Appl. No.: 12/533,739

(22) Filed: Jul. 31, 2009

(51) Int. Cl. G06F 9/46

(52) U.S. Cl. 718/107

(57) ABSTRACT

An approach is provided for coordination resource access. A resource access coordinating application determines the conflict condition among a plurality of queries from a respective plurality of applications for access to an identical resource in an information space. The resource access coordinating application then orders the queries based on one or more characteristics (e.g., read, write, update, delete, read-only, read-update, write-update, write-add, write-add, etc.) of the queries irrespective of the applications. Thereafter, the resource access coordinating application selects one of the queries based on the order.

### BACKGROUND

Service providers (e.g., wireless and cellular services) and device manufacturers are continually challenged to deliver value and convenience to consumers by, for example, providing compelling network services and advancing the underlying technologies. One area of interest has been in ways to resolve resource access conflicts while maintaining a level of service acceptable to users. Resource access queries have substantially increased due to the increasing of online users and information. As users continue to increase their reliance on data retrieved from networks, more resource access queries are inserted in the semantic space and other evolving information spaces (e.g., smart spaces), thereby increasing the possibility of conflicted access requests to the same resources.

### SOME EXAMPLE EMBODIMENTS

Therefore, there is a need for an approach for coordinating resource access in an information space, namely smart spaces.

According to one embodiment, a method comprises determining a conflict condition among a plurality of queries from a respective plurality of applications for access to an identical resource in an information space. The method also comprises ordering the queries based on one or more characteristics of the queries irrespective of the applications. The method further comprises selecting one of the queries based on the order.

According to another embodiment, an apparatus comprising at least one processor, and at least one memory including computer program code, the at least one memory and the computer program code configured to, with the at least one processor, cause the apparatus to determine a conflict condition among a plurality of queries from a respective plurality of applications for access to an identical resource in an information space. The apparatus is also caused to order the queries based on one or more characteristics of the queries irrespective of the applications. The apparatus is further caused to select one of the queries based on the order.

According to another embodiment, a computer-readable storage medium carrying one or more sequences of one or more instructions which, when executed by one or more processors, cause an apparatus to determine a conflict condition among a plurality of queries from a respective plurality of applications for access to an identical resource in an information space. The apparatus is also caused to order the queries based on one or more characteristics of the queries irrespective of the applications. The apparatus is further caused to select one of the queries based on the order.

According to another embodiment, an apparatus comprises means for determining a conflict condition among a plurality of queries from a respective plurality of applications for access to an identical resource in an information space. The apparatus also comprises means for ordering the queries based on one or more characteristics of the queries irrespective of the applications. The apparatus further comprises means for selecting one of the queries based on the order.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a smart space logical architecture capable of coordinating resource access in an information space, according to one embodiment;

FIG. 2 is a diagram of the smart space logical architecture including knowledge processors, according to one embodiment;

FIG. 3 is a diagram of the smart space logical architecture including a coordinating knowledge processor, according to one embodiment;

FIG. 4 is a flowchart of a process for coordinating resource access in a smart space, according to one embodiment;

FIG. 5 is a behavior diagram in united modeling language (UML) of a coordinating knowledge processor and knowledge processors, according to one embodiment;

FIG. 6 is a flowchart of another process for coordinating resource access in a smart space, according to one embodiment;

FIG. 7 is a presentation of scheduling using time slots, according to one embodiment;

FIG. 8 is a diagram of a potential resource access conflict caused by simultaneous resource access queries, according to one embodiment;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

A method and apparatus for coordinating resource access in an information space are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

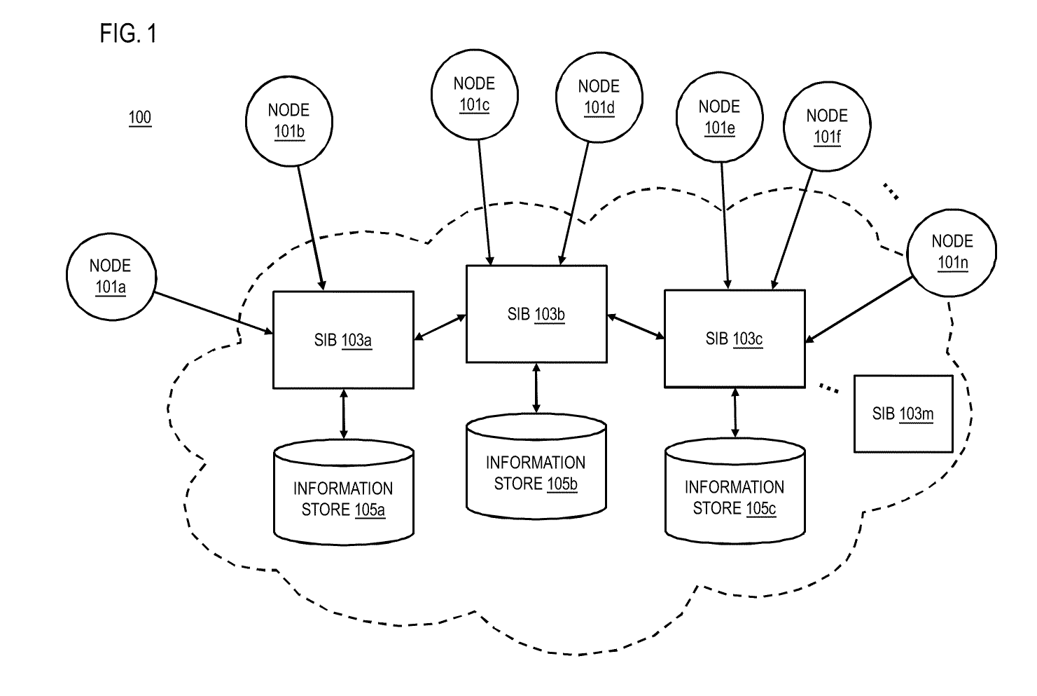

FIG. 1 is a diagram of a smart space logical architecture, according to one embodiment. In this example, each individual smart space 100 is considered as an aggregated information set with information from different sources. For example, a user's personal smart space contains information such as the user's personal information, family information, work information, social network information, etc. which came from all sources. In addition, such information may be serialized via different formats to, for instance, reduce resource requirements for storing the information.

As used herein, the term “resource” refers to data or anything else capable of being defined in the semantic web for completing a project activity, such as people, equipment, facilities, funding, etc. Resource scheduling, availability and optimization are considered in project management. A resource can be a piece of data that a service provides to its users or allows its user to share. Familiar examples include an electronic document, an image, a service (e.g., “today's financial news on the Stock Exchange”), and a collection of other resources. It is noted that not all resources are network “retrievable”, e.g., people, equipment, facilities, funding, bound books in a library, etc. For example, Abstract concepts can be resources, such as the operators and operands of a mathematical equation, the types of a relationship (e.g., “parent” or “employee”), or numeric values (e.g., zero, one, and infinity). Providing a concept is given an identity, either the concept is expressed by an information representation format (e.g., Resource Description Framework (RDF) triples) or structure (e.g., RDF graphs), or its identity is expressed by given a well-formed Uniform Resource Identifier (URL), then the concept can be a resource as well.

As used herein, the term “triple” refers to a subject-predicate-object expression in RDF. The subject denotes the resource, and the predicate denotes traits or aspects of the resource and expresses a relationship between the subject and the object. For example, one way to represent the notion “the manager went to Finland for a business negotiation” in RDF as the triple is: a subject denoting “the manager,” a predicate denoting “went to,” and an object denoting “Finland for a business negotiation.”

The term “semantic web” refers to a universal medium for data, information, and knowledge exchange. This information exchange inserts documents with computer-comprehensible meaning (semantics) and makes them available on the semantic web. The semantic web is a “web of data” instead of the “web of documents”. Knowledge in the semantic web is structured and organized at a finer level of granularity than free-text document, and the vocabulary includes not only literal words but also universal identifiers.

The term “smart space” refers to a plurality of information spaces of different entities in a “smart space architecture” that allows the entities and different semantic web tools to access heterogeneous information embedded in different semantic domains available for different semantic web tools as described herein.

The conventional mechanisms for solving resource access conflict problems include transactions (which are commonly used in database management systems), semaphores and monitors (which are commonly used in programming), cannot be applied directly to a smart space. For example, in computer science, the set of properties comprising Atomicity, Consistency, Isolation, Durability (ACID) are used to process database transactions reliably. However, such general and high level concepts cannot be used directly in the smart space architecture which contains information sent from different sources and configured in different representation formats and structures.

To address this problem, a resource access coordinating application as described herein is designed to coordinate resource access queries in the smart space by ordering the queries based on one or more characteristics of the queries irrespective of the applications and the nodes using the applications, while still fully preserving anonymity of the nodes and applications in an information space. In the smart space, a user can use one or more nodes (e.g., mobile telephones, computers, and similar terminals) to perform tasks without knowing anything about the nodes, and the nodes interoperate by communicating implicitly through smart spaces of different users without knowing each other. Such anonymity simplifies control, communication and coordination in the smart space, thereby reducing hardware and software operation time and costs.

The semantic web is designed to share information based upon common representation formats, ontologies and semantics, such that information would become globally ubiquitous and interoperable. However much of the information is not desired to ubiquitous, but remain hidden, private and is interpreted locally, such as personal information. To address to this issue, a smart space architecture (an entity focused structure) is developed such that a user can encapsulate all of personal information and interact with the information in the smart space according to the user's individual semantics and needs. The user can be a person, an organization, or other entity.

As seen in FIG. 1, each smart space is distributed across at least one set of nodes belonging to at least one user. In this embodiment, the smart space 100 is distributed across multiple nodes 101a-101n that each belong to multiple users. For example, nodes 101a and 101b belong to a first user, while nodes 101c-101f belong to a second user. It is also contemplated that one or more of the nodes (e.g., node 101n) may belong to a centralized information provider. Nodes 101 are personal/individual in that they perform tasks either directly decided by the user or autonomously for or on behalf of the user. For example, the nodes 101 can monitor predetermined situations or reason/data-mine information available in the smart space 100.

A node 101 may connect to one or more smart spaces 100 at a time. Moreover, the specific smart spaces 100 and to which the node 101 is connected may vary over the lifetime of a node. Mobility of nodes 101 is provided by moving links to the smart space 100 rather than moving a physical running process of the smart space 100. The node 101 can save its state and become ‘mobile’ when another node 101 restores that state. Nodes 101 themselves are anonymous and independent of each other—there is no explicit control flow between the nodes 101 other than that provided through preconditions to node actions. A coordination model based around expressing coordination structures as first-order entities and focusing on collecting reasoning and context. Control flow can be made outside of the smart space 100 through nodes 101 and the applications serving the nodes 101 explicitly sharing details of their external interfaces through the smart space 100. The responsibilities of nodes 101 range from user-interaction to reasoning and performing tasks such as truth maintenance, belief revision, information consistency management etc.

The nodes 101 access information in the smart space 100 through semantic information brokers (SIB) (e.g., SIBs 103a-103n) by connecting to any of the SIBs 103 making up the smart space 100 by whatever connectivity mechanisms (e.g., connectivity over a data network, the Internet, etc.) the SIBs 103 offer. Usually, the connection is over some network (e.g., data network, wireless network, telephony network, service provider network, etc.), and the nodes 101 are running on various devices. For example, the node 101 may be supported on any type of mobile terminal, fixed terminal, or portable terminal including a mobile handset, station, unit, device, multimedia tablet, Internet node, communicator, desktop computer, laptop computer, Personal Digital Assistants (PDAs), or any combination thereof. It is also contemplated that the device supporting the node 101 can support any type of interface to the user (such as “wearable” circuitry, etc.).

Additionally, a communication network (not shown) capable of supporting the smart space 100 can include one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

Each SIB 103 is an entity performing information transaction operations, possibly co-operating with other SIBs 103, for the smart space 100. In one embodiment, an SIB 103 may be a concrete or virtual entity. Each SIB 103 supports nodes 101 interacting with other SIBs 103 through information transaction operations. In this embodiment, the smart space 100 includes SIBs 103a-103m each connected to respective information stores 105a-105c. Each information store 105 of the smart space 100 stores the information of the nodes 101, and any other information available over the smart space 100. This can include, for example, information of a current state or activity of the node 101, observations of the outside information world, maintenance information, and the like. Synchronization between these distributed, individual information stores 105 is asymmetric according to device and network capabilities as well as the user's needs in terms of security, privacy, etc. For example, private information about a user's family is stored at the user's home location where stricter information security policies can protect the information. The private information can then be augmented by non-private information at a website (e.g., a social networking website) without actually transferring the private information to the website. In this case, augmenting information is preferable to merging information due to, for instance, copyright and/or privacy concerns.

A smart space 100 transcends over many of the user's devices (e.g., mobile phones, media centers, personal computers, servers, routers, etc.) enabling the distribution of information and queries upon that information over any of the user's devices. For any node 101 accessing the information, the physical location of the node 101 and the location of the information are irrelevant, i.e., a node 101 sees the ‘totality’ of all information in that smart space 100. By way of example, the nodes 101 access the smart space 100 with basic operations including Insert (to insert information into a smart space), Remove (to remove information from a smart space), Update (to update information in a smart space, which is effectively an atomic remove and insert combination), Query (to query for information in a smart space), Subscribe (to set up a persistent query in a smart space such that a change in the query results is communicated to the subscribing node), etc. The nodes 101 communicate implicitly by inserting information to the smart space 100 and querying the information in the space 100.

Interaction among smart spaces 100 is nominally conducted by the nodes 101 which encapsulate fine grained functionality to be distributed across any number of devices that have access to one or more of the smart spaces 100. The smart spaces 100 themselves can interact through merging and projection thereby enabling larger smart spaces 100 to be constructed either on a permanent or temporary basis. Moreover, the smart space 100 may be a personal space, a share/social space of at least two users, a group space, a public space of a community, a county, a state, or a county, etc., and the like. The aggregation of all smart spaces 100 constitutes the world of information (including the semantic web) which is also referred to as a smart space. A smart space 100 including the entire world of information also supports all services (including all platforms and vendors) available in the world, as well as all of the world's devices and equipment.

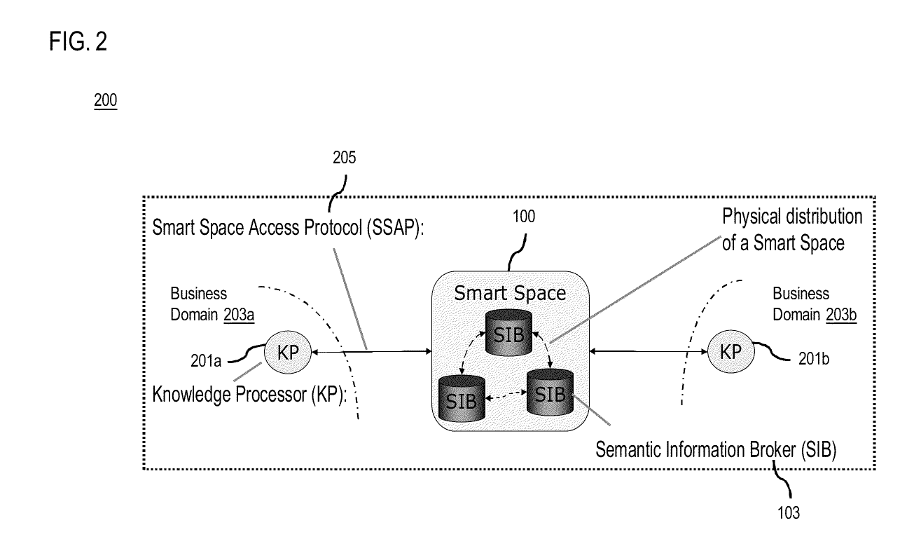

The rules of information usage (e.g., as provided in applications) for the smart space 100 are implemented in knowledge processors (KP) (e.g., KP 201a and 201b) connected to the smart space 100 via SIBs 103. FIG. 2 is a diagram of the smart space logical architecture including KPs, according to one embodiment. In one embodiment, the SIBs 103 are responsible for storing and sharing smart space information. For example, as soon as an information unit becomes available for the SIB 103, the information unit also becomes available for every KP 201 served by the SIB 103. The KPs 201, for instance, are responsible for processing information obtained from the SIBs 103. A KP 201a uses one or more partner KPs 201b for sharing of content. This partnership arrangement implies that there is an agreed set of semantics among the KPs 201a-201b for the used ontology. KPs 201a and 201b may run in different business domains (e.g., business domain 203a and 203b respectively) to allow the public or public entities to access the same information service regardless of which business domain 203 the public or public entities are located. In the smart space 100, a smart space access protocol (SSAP) 205 is used between the SIBs 103 and KPs 201, among SIBs 103, and among KPs 201 to, e.g., join, leave, insert, remove, update, query, subscribe, and/or unsubscribe information.

The smart space 100 is interoperable over different information domains, different service platforms, and different devices and equipment. For example, the smart space 100 accommodates transmission control protocol/Internet protocol (TCP/IP), Unified Protocol (UniPro) created by the Mobile Industry Processor Interface (MIPI) Alliance, Bluetooth protocol Radio Frequency Communication (RFCOMM), IPv6 over Low power Wireless Personal Area Networks (6LoWPAN), etc. The smart space 100 also covers technologies used for discovering and using services, such as Bluetooth/human interface device (HID) services, web services, services certified by the Digital Living Network Alliance (DLNA), the Network on Terminal Architecture (NoTA), etc. The smart space constitutes an infrastructure that enables scalable producer-consumer transactions for information, and supports multiparts, multidevices and multivendors (M3), via a common representation of a set of concepts within a domain (such as a RDF domain) and the relationships between those concepts, i.e. ontologies. The smart space 100 as a logical architecture has no dependencies on any network architecture but it is implemented on top of practically any connectivity solution. Since there is no specific service level architecture in the smart space 100, the smart space 100 has no limitation in physical distance or transport. The smart space 100 architecture allows user devices purchased at different times and from different vendors to work together. For example, the user can listen/watch/etc. to music/movies/etc. wherever the user is using one personal device in the vicinity of high quality speakers or display. In addition, the smart space 100 architecture allows application developers to mash-up services in different domains, instead of trying to port an application to all platforms and configurations. The smart space architecture also allows device manufacturers to make interoperable products, so that consumers have no concern about compatibility of different products and accessories.

Various embodiments are described herein with respect to coordinating access to resources in the semantic web and the smart space. Although the resource description framework (RDF) is frequently used as an example, it is contemplated that the approach described herein may be used with other semantic web tools, such as a variety of data interchange formats (e.g. RDF/XML, N3, Turtle, N-Triples), and notations such as RDF Schema (RDFS) and the Web Ontology Language (OWL), which are intended to provide a formal description of concepts, terms, and relationships within a given knowledge domain.

By way of example, RDF is used in the smart space 100 to store information in information stores 105a-105c. RDF allows joining data in vocabularies from different business domains 201a and 201b without having to negotiate structural differences between the vocabularies. In addition, via the RDF, the smart space 100 merges the information of the embedded domains with the information on the semantic web, as well as makes the vast reasoning and ontology theories, practices and tools developed by the semantic web community available for application development in the smart space 100. The smart space 100 also makes the heterogeneous information in embedded domains available to the semantic web tools.

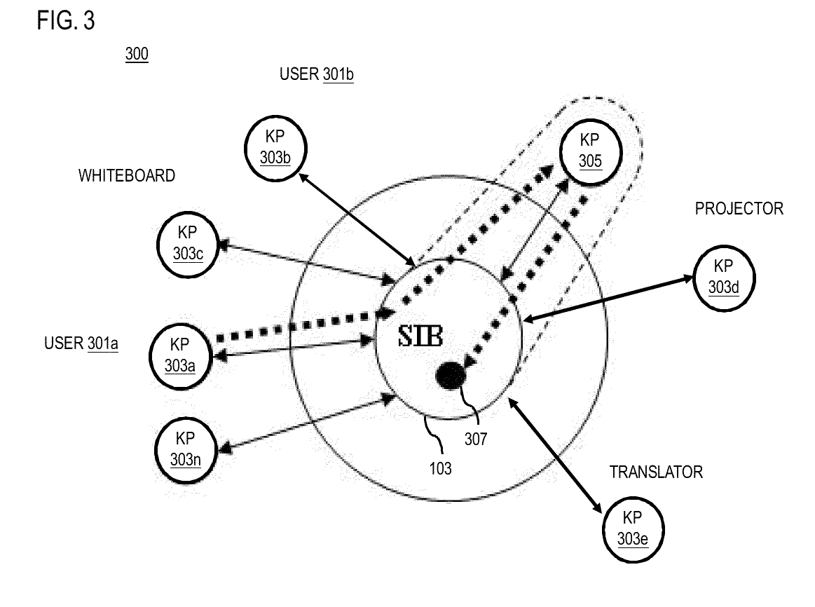

FIG. 3 is a diagram of the smart space logical architecture including a coordinating knowledge processor, according to one embodiment. In the example of FIG. 3, the smart space 100 is currently used by a user 301a and a user 301b. The users 301a and 301b interact with the smart space 100 via their respective knowledge processors, e.g., KP 303a and KP 303b. If the KP 303a of the first user wants to occupy a resource R1, it first checks the availability of R1 by submitting a first triple: {“R1”, “is_occupied_by”, None}, where “None” logically means “any”. If the statement represented by the first triple is valid (e.g., if there is no other entity occupying R1), then KP 303a submits a second triple: {“R1”, “is_occupied_by”, “KP 303a”} to occupy R1.

This approach works as long as the KP 303b of the second user does not try to simultaneously request access to the same resource R1. The term “simultaneously” is defined as occurring within a time interval from the moment when the KP 303a has executed the first triple and until the moment when the KP 303a executes the second triple. If KP 303b submits it triple to check the availability of R1 during this time interval, the KP 303b will receive information that R1 can be occupied even though the KP 303a has already made a similar request and plans to occupy R1. This inconsistency can result in a resource access collision between the KP 303a and the KP 303b. The collision can occur because the both KP 303a and the KP 303b have logical permission to occupy the resource R1 based on responses to their respective first triples. As a consequence, handling of the second triple to occupy the R1 becomes complex and has a high probability of causing logical errors and inconsistencies.

The approach described herein introduces a coordinating knowledge processor (CKP) 305 into the smart space 100 as the resource access coordinating application for resolving the above-described resource conflict. The CKP 305 acts as a resource access manager for the SIB 103 which possesses the resource 307. The conventional resource managing solutions assume presence of a centralized application, to which all other applications send their resource access requests. In the approach described herein, the CKP 305 operates based on smart space principles, and other smart space applications (e.g., other KPs 303c-303n) do not need to know the presence of the CKP 305 (i.e., CKP 305 remains “anonymous”). By way of example, the KPs 303 may be any application that operates within the smart space 100. For example, a whiteboard KP 303c is an application of the smart space 100 for posting items that can be viewed or otherwise accessed by other users, the projector KP 303d is an application of the smart space 100 for displaying or presenting information or data (e.g., information posted to the whiteboard KP) of the smart space 100, and the translator KP 303e is an application of the smart space 100 for translating information or data of the smart space 100 into the user's preferred language.

As shown in FIG. 3, the light dotted lines show that the CKP 305 is associated with the SIB 103, and the dark dotted lines show that the information flowing between the KP 303a of the user 301a and the SIB 103 is routed via the CKP 305. In another embodiment, the same principle of coordination is implemented completely internally inside the SIB by, for instance, including the CKP 305 within the SIB 103 or having the SIB 103 perform the functions of the CKP 305.

The resource access coordinated by the CKP 305 is performed seamlessly, automatically and anonymously by introducing a special set of RDF triples for handling resource access. The CKP 305 subscribes to special triples that monitor all resource access requests/queries. The CKP 305 then handles these requests on behalf of the SIB 103 it is associated with, such that other KPs 303a-303n will not notice the CKP 305.

In one embodiment, the communications between CKP 305 and KPs 303a-303n for coordinating resource access are in a predefined information representation format or structure. By way of example, the RDF triple format (a subject-predicate-object expression in RDF) is adapted for use in such communications. The subject denotes the resource, and the predicate denotes traits or aspects of the resource and expresses a relationship between the subject and the object.

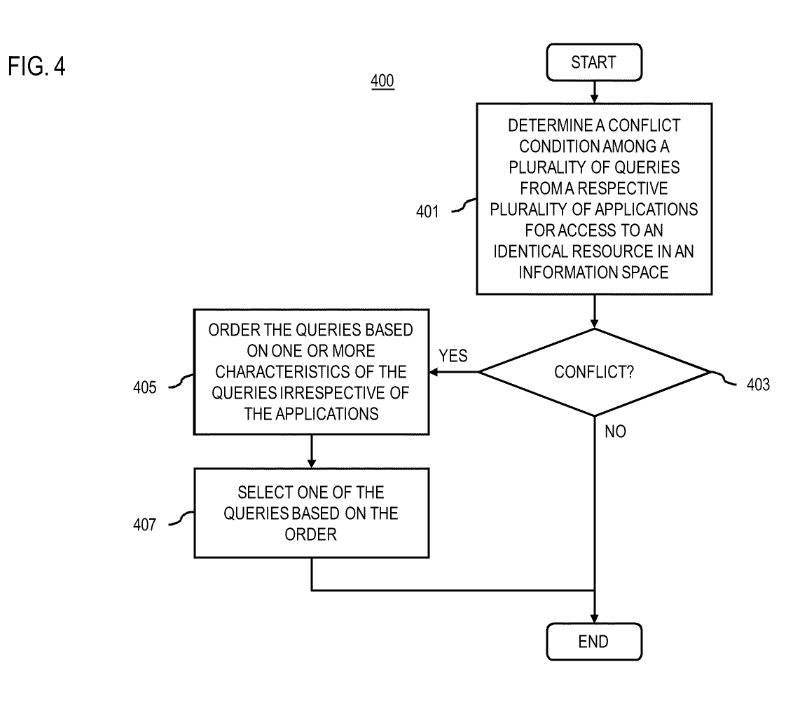

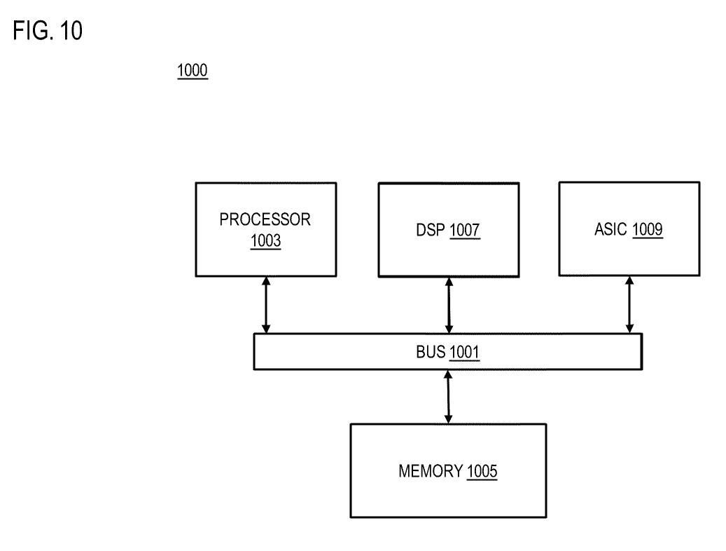

FIG. 4 is a flowchart of a process 400 for coordinating resource access in a smart space, according to one embodiment. As mentioned, the CKP 305 is designed to coordinate simultaneous resource access requests in the smart space 100. In one embodiment, the CKP 305 (e.g., an application) performs the process 400 and is implemented in, for instance, a chip set including a processor and a memory as shown FIG. 10. In step 401, the CKP determines the conflict condition among a plurality of queries from a respective plurality of applications (e.g., KP 303a, KP 303b) for access to an identical resource (e.g., resource 307) in the smart space 100. If a conflict condition is determined (Step 403), the CKP 305 orders the queries based on one or more characteristics (e.g., read, write, update, delete, read-only, read-update, write-update, write-add, write-add, etc.) of the queries irrespective of the applications (Step 405). Allocation of the resources (e.g., resource 307) is based on the priority given to an order of the queries. The order can be arranged randomly, or calculated using the critical path method and heuristic analysis based on the characteristics of the query. The objective may be to create the most efficient schedule possible by minimizing execution duration and maximizing the use of the available resources.

As such, the CKP 305 can order the queries on the fly, rather than being tied to any predefined application hierarchy, user hierarchy, or resource hierarchy. The intrinsic characteristics of the queries are much simpler than characteristics of the application, users, and/or resources which are essentially unlimited in members, difficult to define and complicated by nature. As results, the ordering rules based on application/user/resource are cumbersome for the hardware and software resources in the smart space to implement. Thereafter, the CKP 305 selects one of the queries (e.g., sent from the KP 303a) based on the order (Step 407).

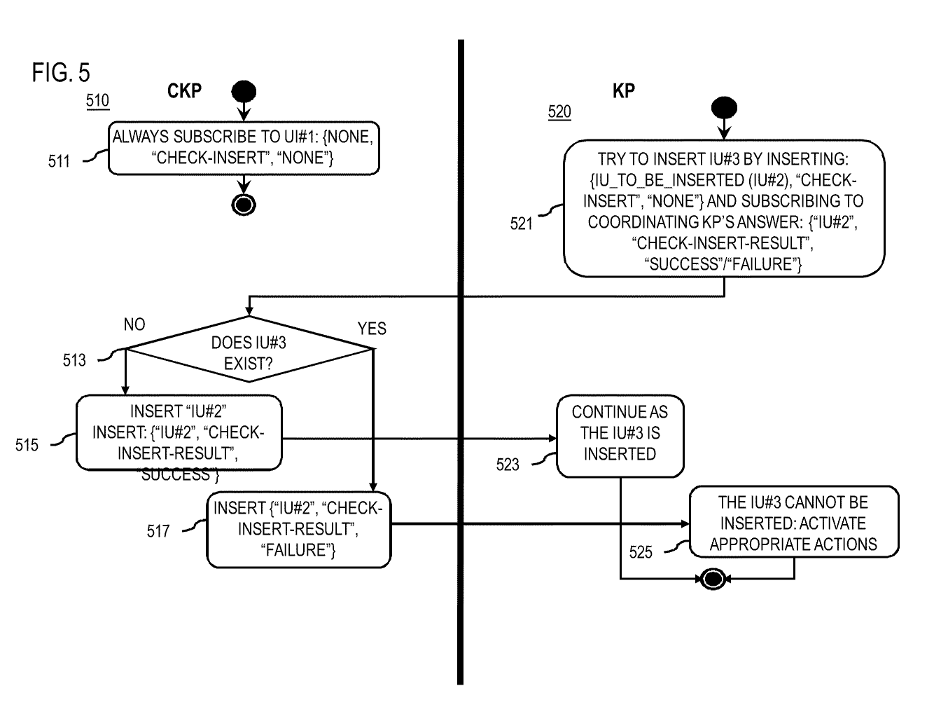

FIG. 5 shows a combined united modeling language (UML) behavior diagram of a CKP 510 and a KP 520, according to one embodiment. As mentioned, the RDF triple is adapted for communications within the smart space 100. Accordingly, the communications between the KP 520 and CKP 510 use the same information representation format. In this embodiment, the CKP 510 subscribes to information unit #1 (“IU#1”) in the smart space 100: {None, “check-insert”, None}, where “None” logically means “any” (Step 511). The IU#1 contains “any resource” as the subject, “check-insert” as the predicate, and “any entities within the smart space” as the object. The entities may be nodes 101, KP 520, SIBs 103, domains of businesses 203, etc. covered by the CKP 510 as freely defined. The entities may connected to the smart space 100 directly or indirectly.

IU#1 {None, “check-insert”, None} allows the CKP 510 to set up a persistent query in the smart space 100 for checking and receiving changes of any resources inserted into the smart space 100 by any entities covered by the CKP 510. Such changes may be triggered by basic smart space operations including Insert, Update, Query, Subscribe, etc. Therefore, the CKP 510 is kept informed by the covered entities of all changes (e.g., including occupation status) of the resources in the smart space 100.

To occupy the resource R1, the KP 520 inserts a first rule into the smart space: {“R1, is_occupied_by, KP 520”, “check-insert”, “None”}, and subscribes to a second rule {“R1, is_occupied_by, KP 520”, “check-insert-result”, None} in Step 521. The first rule {“R1, is_occupied_by, KP 520”, “check-insert”, “None”} contains IU#2: “R1, is_occupied_by, KP 520” as its resource. The first rule triggers the CKP 510 to check whether IU#3 {“R1”, “is_occupied_by”, None} is being inserted or has been inserted in the smart space 100 (Step 513).

The second rule {“R1, is_occupied_by, KP 520”, “check-insert-result”, None} also contains IU#2: “R1, is_occupied_by, KP 520” as its resource. The second rule allows the CKP 510 to answer/reply to KP 520 with a result of the determination of whether IU#3 is being inserted or has been inserted in the smart space 100 (Steps 515-517).

When UI#3 {“R1”, “is_occupied_by”, None} is determined as not existing in the smart space 100, the CKP 510 inserts into the smart space 100 (1) the second IU {“R1”, “is_occupied_by”, “KP 520”} to reserve R1 for KP 520 to access and (2) IU#4 {“R1, is_occupied_by, KP 520”, “check-insert-result”, “success”} as a reply to KP 520 (Step 515). After receiving the reply with a result of “success,” KP 520 proceeds to access R1 (Step 523) since IU#2 was inserted in the smart space by the CKP 510 for KP 520.

When IU#3 {“R1”, “is_occupied_by”, None} exists (i.e., “is being inserted or has been inserted”) in the smart space 100, the CKP 510 inserts IU#5 {“R1, is_occupied_by, KP 520”, “check-insert-result”, “failure”} as a reply to KP 520 (Step 517). After receiving the reply with a result of “failure,” KP 520 proceeds to activate appropriate actins (Step 525), such as inserting new access queries for other resources.

In case of simultaneous inserts of first rules by two KPs (e.g., KP 520 and another KP, not shown but designated as “u2”): (“R1, is_occupied_by, KP 520”, “check-insert”, “None”) and (“R1, is_occupied_by, u2”, “check-insert”, “None”), the CKP 510 selects only one of the KPs (e.g., KP 520) to proceed to Step 513 and its subsequent steps. When KP 520 occupies the resource R1, “u2” has to try to occupy other resource(s). The other resource(s) can be defined internally by “u2”, or offered by the CKP 510 to “u2”.

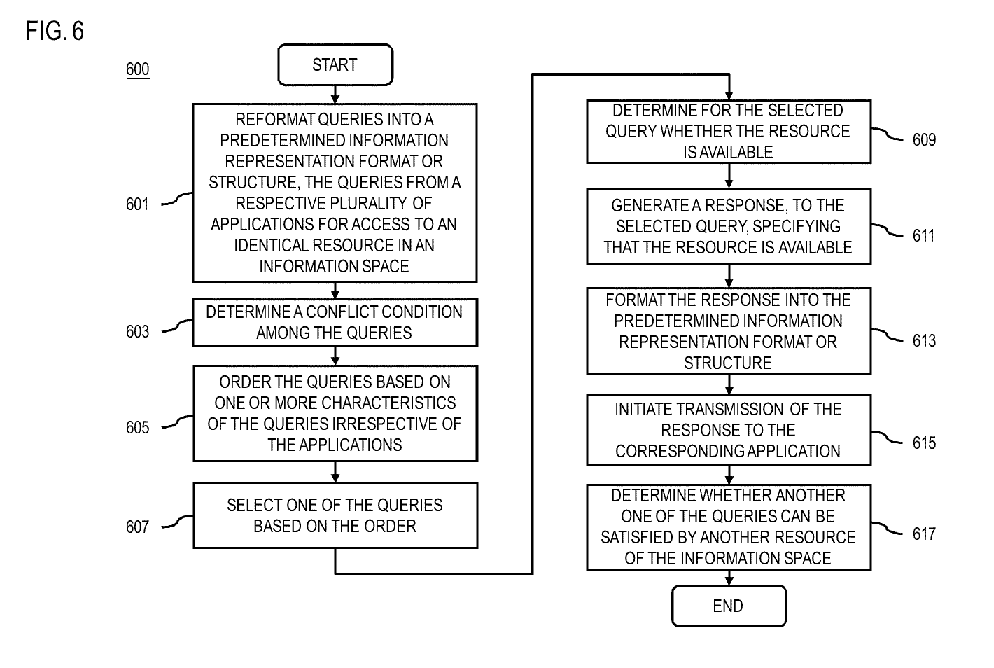

FIG. 6 is a flowchart of another process 600 for coordinating resource access in a smart space, according to one embodiment. In the example of FIG. 6, the coordination function is used for resolving conflicts that arise from conflicted resource access queries to a meeting held in a “smart room” equipped with at least the whiteboard KP 303c, the projector KP 303d, and the translator KP 303e as described with respect to FIG. 3. The “smart room” is, for instance, a specialized smart space 100 created to support a meeting of multiple users using the listed KPs (e.g., KPs 303c-303e). By way of example, a whiteboard KP 303c enables meeting participants to post items for viewing or access by other meeting participants, the projector KP 303d displays or otherwise presents smart space information to meeting participants, and the translator KP 303e translates smart space information into the preferred language of each meeting participant. The meeting participants use their personal devices (e.g., mobile devices, personal computers, etc.) that store personal data such as contact information, areas of interests, presentation materials, etc. Those participants who are going to make presentations have their presentations available locally or via internet/intranet for all meeting participants.

When the meeting participants enter the smart room, their personal devices discover the whiteboard KP 303c and engage a handshaking protocol. If a participant is going to make a presentation, his or her personal device shares relevant user information (such as a name, a photo, a domain of interests, an e-mail, a phone number, etc.) and presentation information (such as a title, keywords, a Uniform Resource Identifier (URI), etc.). As defined previously, the resource may be any data, concepts, actual or physical resources (e.g., presentation time slots in a smart room) that either are expressed by an information representation format or structure (e.g., RDF graphs), or have an identity expressed by a well-formed Uniform Resource Identifier.

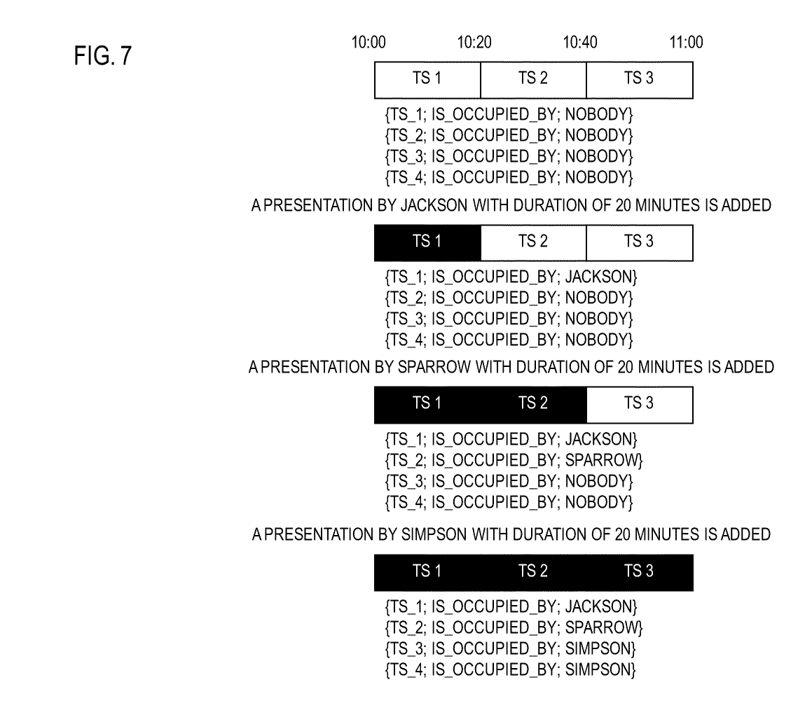

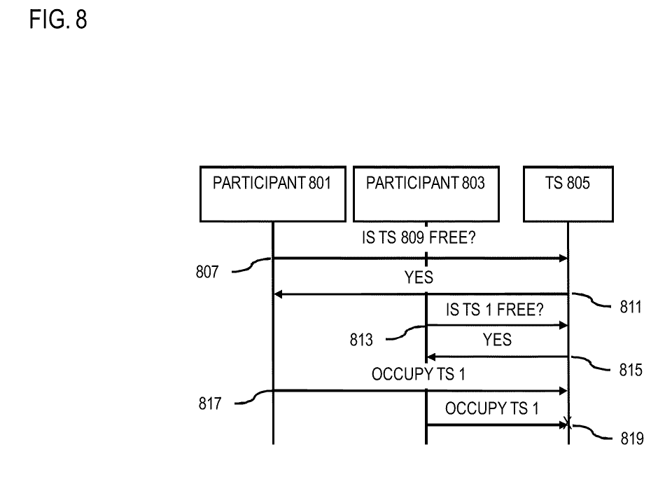

In this example, presentations and meeting agenda items are scheduled according to the process 600. For example, there are several time slots TS1, TS2, TS3 covering the whole time period of the meeting from 10:00 to 11:00. When a user visits the smart room, his/her presentation is scheduled into a free time slot. This is done, for instance, by updating appropriate information units in the smart space 100 of the smart room as illustrated by FIG. 7. FIG. 7 shows the resources (e.g., time slots) reservation process for several meeting participants. e.g., Jackson, Sparrow and Simpson. However, scheduling conflicts can occur if two or more presentations are scheduled in the same time slot simultaneously as shown in FIG. 8.

FIG. 8 is a diagram of a potential resources access conflict caused by simultaneous resource access queries, according to one embodiment. FIG. 8 is a time sequence diagram including three processes representing a meeting participant 801, a meeting participant 803, and a smart room 805. In step 807, the participant 801 queries the smart room 805 to determine whether a TS 809 is free for scheduling a presentation. The smart room 805 responds that TS 805 is available (Step 811). Before the participant 801 is able to respond by sending a request to occupy the TS 809, the participant 803 initiates a query to the smart room 805 to determine whether the same TS 809 is available (Step 813). Because the smart room has not yet received a reply from the first participant 801, the smart room 805 still considers the TS 809 to be available and sends a positive reply to the participant 803 (Step 815). As a result, both the participant 801 and the participant 803 believe that the TS 809 is available, thereby creating a resource conflict with respect to the TS 809. This conflict causes both the participant 801 and the participant 803 to send a request to occupy the same TS 809 (Steps 817 and 819).

Without coordination, the same time slots can be occupied by two or more different presentations or some presentations may be omitted from the agenda. The meeting participants can see the detailed agenda on the screens of their personal devices, but the agenda may look differently for different participants. The situation can be even further complicated when some additional services are implemented, e.g. translating presentations into a preferred language (e.g., using the translator KP 303e, which is also a part of the smart space 100) for each participant. For example, to initiate translation, the information of a preferred language is extracted from the user profile. The translator KP 303e may translate the information with its own resources or via an interface to one of the existing Internet translation services.

In order to avoid the above-described problem, the smart space 100 further includes the CKP 510. As shown in FIG. 5, the CKP 510 has knowledge of the entire smart space 101 by subscribing to UI#1: {None, “check-insert”, None}.

Returning to FIG. 6, the CKP 510 reformats queries into a predetermined information representation format or structure (i.e., RDF) if necessary (Step 601). For example, if the queries sent from different applications such as the whiteboard KP 303c, the projector KP 303d, a translator KP 303e, etc. are in a different information representation format or structure, the CKP 510 reformats the queries. In this example, the queries are sent from one or more applications (e.g., KPs 303c-303e) to access to an identical resource (e.g., resource 307) in the smart space 100, thereby creation a resource conflict.

The entities (e.g. applications, KPs 303, etc.) requesting the same resource are designated herein as “u1”, “u2”, and “u3”. If the CKP 510 is not available in the smart space 100 of the smart room and “u1” wants to occupy the time slot “TS_{—}1” in the smart room, “u1” simply checks in the smart room whether the information unit: {“TS_{—}1”, “is_occupied_by”, None} is valid. If the statement is valid, “u1” submits the triple: {“TS_{—}1”, “is_occupied_by”, “u1”} to occupy TS_{—}1.

When the CKP 510 is available, “u1” inserts the following inference rule into the smart space of the smart room: {“TS_{—}1, is_occupied_by, u1”, “check-insert”, “None”} instead, and subscribes to {“TS_{—}1, is_occupied_by, u1”, “check-insert-result”, None}.

When the CKP 510 determines a conflict condition among the queries (Step 603), the CKP 510 orders or arranges the queries based on one or more characteristics of the queries irrespective of the requesting applications or entities (Step 605), and then selects one of the queries based on the order (Step 607) as performed in the process 400.

The CKP 510 then determines for the selected query whether the resource is available (Step 609) according to the behaviors depicted in FIG. 5, by checking the existence of the triple in the smart space: {“TS_{—}1”, “is_occupied_by”, None}. The CKP 510 generates a response, to the selected query, specifying that the resource is available (Step 611), and formats the response into the predetermined information representation format or structure (Step 613). If the triple exists, the CKP 510 inserts in the smart space a triple {“TS_{—}1, is_occupied_by, u1”, “check-insert-result”, “failure”}, “u1” then receives a result of “failure” since it is subscribed. If the triple does not exist, the Coordinating KP inserts into the smart space a triple {“TS_{—}1”, “is_occupied_by”, “u1”} and a triple {“TS_{—}1, is_occupied_by, u1”, “check-insert-result”, “success”}. The “u1” then receives a result of “success” since it is subscribed. The CKP 510 initiates transmission of the response to the corresponding application (Step 615).

In other words, in case of simultaneous insertion of two inference rules by two respective KPs (u1 and u2): (“TS_{—}1, is_occupied_by, u1”, “check-insert”, “None”) and (“TS_{—}1, is_occupied_by, u2”, “check-insert”, “None”), the CKP 510 inserts the rule for only one of the KPs (e.g., “u1”) and does not insert it for the other KP. After the CKP 510 resolves the conflict, “u1” occupies the time slot TS1, and “u2” can try to occupy another time slot. Optionally, the CKP 510 can determine whether another one of the queries can be satisfied by another resource of the smart space 100 (Step 617).

This scenario has been simulated using six personal computers (a PC controlling the whiteboard, a PC controlling the projector, a PC controlling the Coordinator, a PC controlling the Translator, two PCs emulating two users' devices), and one Internet Tablet (e.g., a Nokia® N810 Internet table) emulating the users' personal devices. The knowledge processors were implemented using a general-purpose high-level programming language (e.g., Python). Tables 1-7 represent the outputs or different KPs 303 at different stages of the scenario.

Table 1 shows the output of the KP of a first meeting participant (e.g., Jackson in FIG. 7), which presentation was assigned to a first time slot (e.g., 10:00-10:20).

TABLE 1

~/sib/SmartRoom $ python user.py
Manual Discovery. Enter details:
SmartSpace name >TestSpace
SmartSpace IP Address: >192.168.0.103
SmartSpace Port >10010
TestSpace 192.168.0.103 10010
(‘TestSpace’, (<class Node.TCPConnector at 0x4057ba20>,
(‘192.168.0.103’, 10010)))
--- Member of SS: [‘TestSpace’]
Try to occupy timeslot: TS_1
Result from coordinator: success
My presentation: 10:00-10:20
Press any key if you are bored to wait

Table 2 shows the output of the KP of a second meeting participant (e.g., Sparrow). The presentation was assigned to a second time slot (e.g., 10:20-10:40). In addition, the designated translation of the presentation keywords is English (default).

TABLE 2
C:\W\Python26\SmartRoom> python user2.py
Manual Discovery. Enter details:
SmartSpace name >TestSpace
SmartSpace IP Address >192.168.0.103
SmartSpace Port >10010
TestSpace 192.168.0.103 10010
(‘TestSpace’, (<class Node.TCPConnector at 0x00c38DE0>,
(‘192.168.0.103’, 10010)))
--- Member of SS: [‘TestSpace’]
Try to occupy timeslot: TS_1
Press any key if you are bored to wait
Result from coordinator: failure
(True, (u′TS_1, is_occupied_by, u2′, u′check-insert-result′, u′failure′))
Try to occupy timeslot: TS_2
(True, (u′TS_2, is_occupied_by, u2′, u′check-insert-result′, u′success′))
My presentation: 10:20-10:40

Table 3 shows the KP of a third meeting participant (e.g., Simpson). His/her presentation was assigned to a third time slot (e.g., 10:40-11:00). The translation of current presentation key words is set as Finnish. The log of the entire scenario is presented with keywords of three presentations translated one after another.

TABLE 3
C:\W\Python26\SmartRoom> python user2.py
Manual Discovery. Enter details:
SmartSpace name >TestSpace
SmartSpace IP Address >192.168.0.103
SmartSpace Port >10010
TestSpace 192.168.0.103 10010
(‘TestSpace’, (<class Node.TCPConnector at 0x00c38DE0>,
(‘192.168.0.103’, 10010)))
--- Member of SS: [‘TestSpace’]
Try to occupy timeslot: TS_1
Press any key if you are bored to wait
Result from coordinator: failure
(True, (u′TS_1, is_occupied_by, u3′, u′check-insert-result′, u′failure′))
Try to occupy timeslot: TS_2
Result from coordinator: failure
(True, (u′TS_2, is_occupied_by, u3′, u′check-insert-result′, u′failure′))
Try to occupy timeslot: TS_3
Result from coordinator: success
(True, (u′TS_3, is_occupied_by, u3′, u′check-insert-result′, u′success′))
My presentation: 10:40-11:00
Try to translate (request to translator KP): apple, milk, maize , language: fi
Keywords of current presentation: omena, maito, maissi
Try to translate (request to translator KP): train, airplane , engine, tram ,
language: fi
Keywords of current presentation: juna, lentokone , moottori, raitiovaunu
My presentation started...
Try to translate (request to translator KP): fire, ill, hospital , language: fi
Keywords of current presentation: rovio, sairas, sairaala

The execution log of the Coordinating KP is shown in Table 4. CKP lets the UKP of the first participant to occupy the time slot TS 1, the second participant to occupy the time slot TS 2, and the third participant to occupy the time slot TS 3.

TABLE 4

C:\W\Python26\SmartRoom> python user2.py
Manual Discovery. Enter details:
SmartSpace name >TestSpace
SmartSpace IP Address >192.168.0.103
SmartSpace Port >10010
TestSpace 192.168.0.103 10010
(‘TestSpace’, (<class Node.TCPConnector at 0x00c38DE0>,
(‘192.168.0.103’, 10010)))
--- Member of SS: [‘TestSpace’]
Press any key if you are bored to wait
Request from user u1 to timeslot TS_1 success.
Request from user u2 to timeslot TS_1 failure
Request from user u2 to timeslot TS_2 success.
Request from user u3 to timeslot TS_1 failure
Request from user u3 to timeslot TS_2 failure
Request from user u3 to timeslot TS_3 success.

Table 5 shows a presentations registration log of the whiteboard KP, according to one embodiment. The output of the whiteboard KP is also shown in Table 5. Table 5 demonstrates how the agenda is built based on users entering the room and occupying presentation time slots. Then, during the meeting, the current presentation is highlighted (with three asterisks).

TABLE 5
C:\W\Python26\SmartRoom> python user2.py
Manual Discovery. Enter details:
SmartSpace name >TestSpace
SmartSpace IP Address >192.168.0.103
SmartSpace Port >10010
TestSpace 192.168.0.103 10010
(‘TestSpace’, (<class Node.TCPConnector at 0x00c38DE0>,
(‘192.168.0.103’, 10010)))
--- Member of SS: [‘TestSpace’]
Press any key if you are bored to wait
Agenda for today:
Time: 10:00-10:20 - Alice Jackson presents: Healthy products for people
Agenda for today:
Time: 10:00-10:20 - Alice Jackson presents: Healthy products for people
Time: 10:20-10:40 - Jack Sparrow presents: Vehicles in modern life
Agenda for today:
Time: 10:00-10:20 - Alice Jackson presents: Healthy products for people
Time: 10:20-10:40 - Jack Sparrow presents: Vehicles in modern life
Time: 10:40-11:00 - Lisa Simpson presents: Accidents in modern world
Agenda for today:
Time: 10:00-10:20 - Alice Jackson presents: Healthy products for people
Time: 10:20-10:40 - Jack Sparrow presents: Vehicles in modern life
Time: 10:40-11:00 - Lisa Simpson presents: Accidents in modern world
Agenda for today:
Time: 10:00-10:20 - Alice Jackson presents: Healthy products for people
Time: 10:20-10:40 - Jack Sparrow presents: Vehicles in modern life
Time: 10:40-11:00 - Lisa Simpson presents: Accidents in modern world
Agenda for today:
Time: 10:00-10:20 - Alice Jackson presents: Healthy products for people
Time: 10:20-10:40 - Jack Sparrow presents: Vehicles in modern life
Time: 10:40-11:00 - Lisa Simpson presents: Accidents in modern world

Table 6 shows the log of projector KP. The log of the projector KP is updated are shown in Table 6.

TABLE 6

C:\W\Python26\SmartRoom> python user2.py
Manual Discovery. Enter details:
SmartSpace name >TestSpace
SmartSpace IP Address >192.168.0.103
SmartSpace Port >10010
TestSpace 192.168.0.103 10010
(‘TestSpace’, (<class Node.TCPConnector at 0x00c38DE0>,
(‘192.168.0.103’, 10010)))
--- Member of SS: [‘TestSpace’]
Press any key if you are bored to wait
Presentation: http://example.com/u1/healthyproduct.ppt is shown
Presentation: http://example.com/u2/cars.ppt is shown
Presentation: http://example.com/u3/accidents.ppt is shown

Table 7 shows the log of the Translator KP.

TABLE 7

C:\W\Python26\SmartRoom> python user2.py
Manual Discovery. Enter details:
SmartSpace name >TestSpace
SmartSpace IP Address >192.168.0.103
SmartSpace Port >10010
TestSpace 192.168.0.103 10010
(‘TestSpace’, (<class Node.TCPConnector at 0x00c38DE0>,
(‘192.168.0.103’, 10010)))
--- Member of SS: [‘TestSpace’]
Press any key if you are bored to wait
Translation started, request from u2 , lang: en
translation completed: apple, milk, maize
Translation started, request from u3 , lang: fi
translation completed: omena, maito, maissi
Translation started, request from u1 , lang: en
translation completed: apple, milk, maize
Translation started, request from u3 , lang: fi
translation completed: juna, lentokone , moottori, raitiovaunu
Translation started, request from u2 , lang: en
translation completed: teach, aeroplane , engine, lorry
Translation started, request from u2 , lang: en
translation completed: shoot, sick, hospital
Translation started, request from u1 , lang: en
translation completed: shoot, sick, hospital
Translation started, request from u3 , lang: fi
translation completed: rovio, sairas, sairaala

The approach, according to certain embodiments, described herein resolves conflicts that may arise due to simultaneous access queries to the same resource. As a consequence, a reliable and robust service can be provided in the smart space even in highly dynamic multi-user use cases, while still fully preserving anonymity of the nodes.

The processes described herein for coordinating resource access in an information space may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

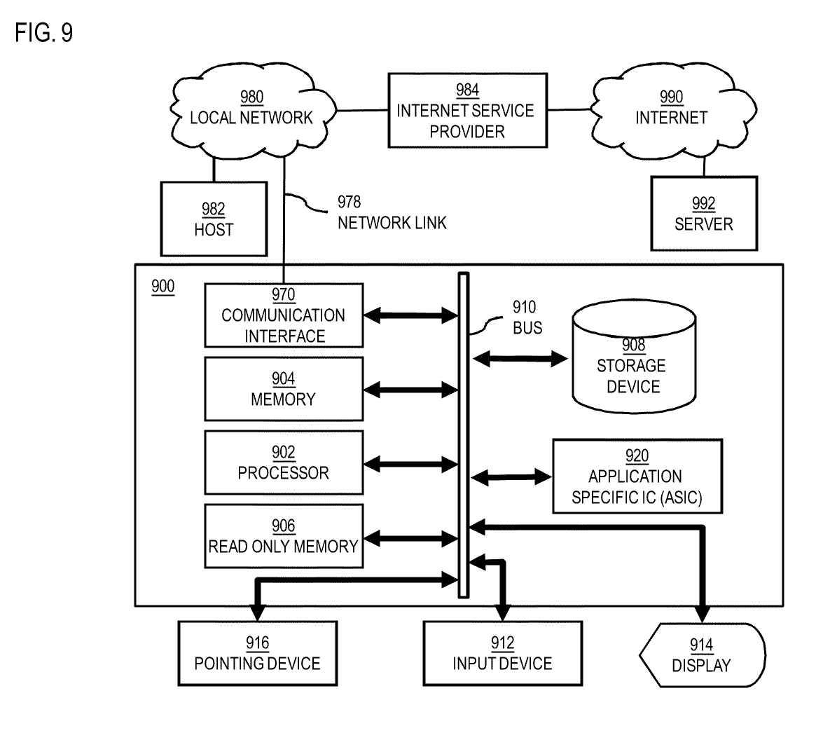

FIG. 9 illustrates a computer system 900 upon which an embodiment of the invention may be implemented. Computer system 900 is programmed (e.g., via computer program code or instructions) to coordinate resource access in an information space as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of coordinating resource access in an information space.

A bus 910 includes one or more parallel conductors of information so that information is transferred quickly among devices coupled to the bus 910. One or more processors 902 for processing information are coupled with the bus 910.

A processor 902 performs a set of operations on information as specified by computer program code related to coordinate resource access in an information space. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or other dynamic storage device, stores information including processor instructions for coordinating resource access in an information space. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for coordinating resource access in an information space, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network for coordinating resource access in an information space to user devices.

The term computer-readable medium is used herein to refer to any medium that participates in providing information to processor 902, including instructions for execution. Such a medium may take many forms, including, but not limited to, non-volatile media, volatile media and transmission media. Non-volatile media include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990. A computer called a server host 992 connected to the Internet hosts a process that provides a service in response to information received over the Internet. For example, server host 992 hosts a process that provides information representing video data for presentation at display 914.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set 1000 upon which an embodiment of the invention may be implemented. Chip set 1000 is programmed to coordinate resource access in an information space as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1000, or a portion thereof, constitutes a means for performing one or more steps of coordinating resource access in an information space.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to coordinate resource access in an information space. The memory 1005 also stores the data associated with or generated by the execution of the inventive steps.

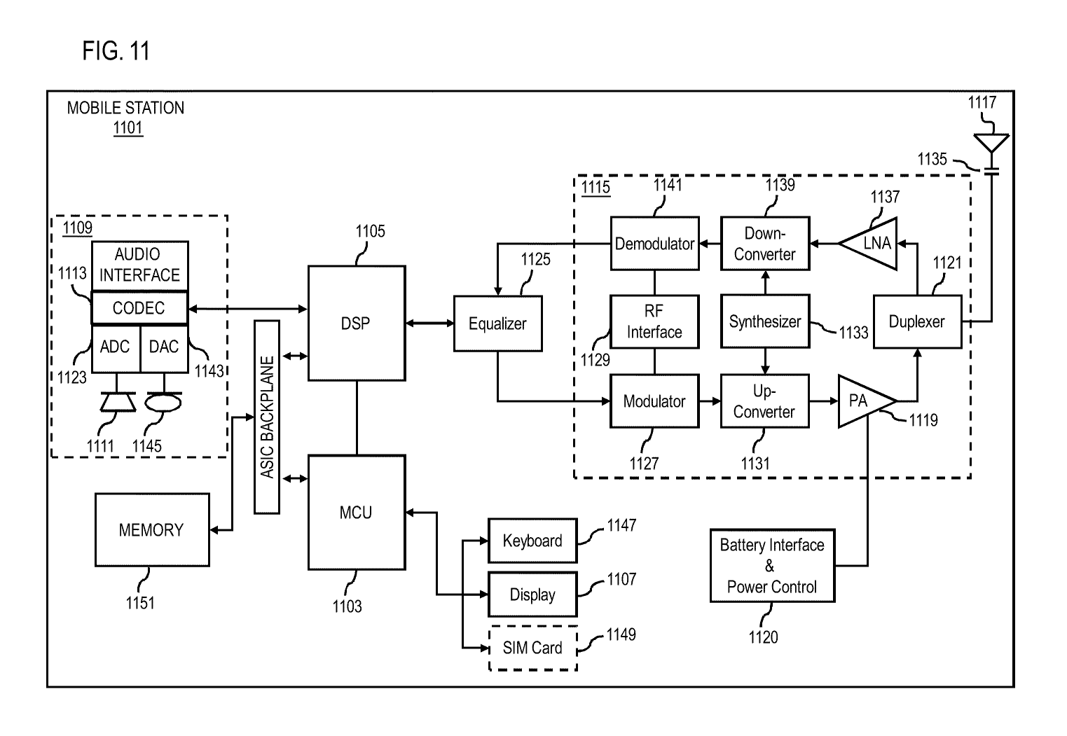

FIG. 11 is a diagram of exemplary components of a mobile terminal (e.g., handset) for communications, which is capable of operating in the system of FIG. 1, according to one embodiment. In some embodiments, mobile terminal 1100, or a portion thereof, constitutes a means for performing one or more steps of coordinating resource access in an information space. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application, the term “circuitry” would also cover an implementation of merely a processor (or multiple processors) and its (or their) accompanying software/or firmware. The term “circuitry” would also cover, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of coordinating resource access in an information space. The display unit 1107 includes display circuitry configured to display at least a portion of a user interface of the mobile terminal (e.g., mobile telephone). Additionally, the display unit 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to coordinate resource access in an information space. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining a conflict condition among a plurality of queries from a respective plurality of applications for access to an identical resource in an information space;
ordering the queries based on one or more characteristics of the queries irrespective of the applications; and
selecting one of the queries based on the order.

2. A method of claim 1, further comprising:
determining for the selected query whether the resource is available.

3. A method of claim 2, further comprising:
generating a response, to the selected query, specifying that the resource is available; and
initiating transmission of the response to the corresponding application.

4. A method of claim 1, further comprising:
determining whether another one of the queries can be satisfied by another resource of the information space.

5. A method of claim 1, wherein the characteristics include read, write, update, delete, read-only, read-update, write-update, write-add, or write-add.

6. A method of claim 1, further comprising at least one of:
reformatting the queries into a predetermined information representation format or structure; and
formatting the response into the predetermined information representation format or structure.

7. A method of claim 1, wherein each of the queries from the applications includes at least one rule and one persistent query, the rule is inserted into the information space to try to occupy the resource, and the persistent query is subscribed to receive a determination of whether the resource is being occupied.

8. An apparatus comprising:
at least one processor; and
at least one memory including computer program code,
wherein the at least one memory and the computer program code configured to, with the at least one processor, cause the apparatus to perform at least the following:
determine a conflict condition among a plurality of queries from a respective plurality of applications for access to an identical resource in an information space;
order the queries based on one or more characteristics of the queries irrespective of the applications; and
select one of the queries based on the order.

9. An apparatus of claim 8, wherein the apparatus is further caused to:
determine for the selected query whether the resource is available.

10. An apparatus of claim 9, wherein the apparatus is further caused to:
generate a response, to the selected query, specifying that the resource is available; and
initiate transmission of the response to the corresponding application.

11. An apparatus of claim 8, wherein the apparatus is further caused to:
determine whether another one of the queries can be satisfied by another resource of the information space.

12. An apparatus of claim 8, wherein the characteristics include read, write, update, delete, read-only, read-update, write-update, write-add, or write-add.

13. An apparatus of claim 8, wherein the apparatus is further caused to:
reformat the queries into a predetermined information representation format or structure; and
format the response into the predetermined information representation format or structure.

14. An apparatus of claim 8, wherein each of the queries from the applications includes at least one rule and one persistent query, the rule is inserted into the information space to try to occupy the resource, and the persistent query is subscribed to receive a determination of whether the resource is being occupied.

15. A computer-readable storage medium carrying one or more sequences of one or more instructions which, when executed by one or more processors, cause an apparatus to perform at least the following:
determining a conflict condition among a plurality of queries from a respective plurality of applications for access to an identical resource in an information space;
ordering the queries based on one or more characteristics of the queries irrespective of the applications; and
selecting one of the queries based on the order.

16. A computer-readable storage medium of claim 15, wherein the apparatus is caused to further perform:
determining for the selected query whether the resource is available.

17. A computer-readable storage medium of claim 16, wherein the apparatus is caused to further perform:
generating a response, to the selected query, specifying that the resource is available; and
initiating transmission of the response to the corresponding application.

18. A computer-readable storage medium of claim 15, wherein the apparatus is caused to further perform:
determining whether another one of the queries can be satisfied by another resource of the information space.

19. A computer-readable storage medium of claim 15, wherein the characteristics include read, write, update, delete, read-only, read-update, write-update, write-add, or write-add.

20. A computer-readable storage medium of claim 15, wherein the apparatus is caused to further perform:
reformatting the queries into a predetermined information representation format or structure; and
formatting the response into the predetermined information representation format or structure.
